(19) United States
(12) Patent Application Publication
(10) Pub. No.: US 2018/0266573 A1
(43) Pub. Date: Sep. 20, 2018

(54) High Pressure Plug Valve

(71) Applicant: Kerr Machine Co., Sulphor, OK (US)

(72) Inventors: Mark S. Nowell, Ardmore, OK (US); Kelcy Jake Foster, Ardmore, OK (US); Michael Eugene May, Ardmore, OK (US); Brandon Scott Ayres, Ardmore, OK (US)

(21) Appl. No.: 15/955,128

(22) Filed: Apr. 17, 2018

Related U.S. Application Data
(63) Continuation-in-part of application No. 15/280,642, filed on Sep. 29, 2016.
(60) Provisional application No. 62/486,273, filed on Apr. 17, 2017.
(60) Provisional application No. 62/346,915, filed on Jun. 7, 2016.
(60) Provisional application No. 62/318,542, filed on Apr. 5, 2016.
(60) Provisional application No. 62/315,343, filed on Mar. 30, 2016.
(60) Provisional application No. 62/234,483, filed on Sep. 29, 2015.

(51) Int. Cl. F16K 5/04; F16J 15/06

(52) U.S. Cl. CPC F16K 5/0407; F16K 5/185; F16K 5/0478; F16J 15/062

(57) ABSTRACT

A plug valve having an improved sealing assembly. The valve has a body, and a bore formed in the body. The bore is configured to receive a plug and an insert. Recesses are formed in the valve in the internally disposed surface of the bore for placement of seals, which interact with an externally disposed sealing surface of the insert. The plug and insert have complementary surfaces that prevent fluid from passing through the annulus between the plug and insert.

### BACKGROUND

This technology relates generally to sealing the through-bore of a plug valve suited for high pressure oil and gas production systems.

Generally, a valve forms a flow passage and has a selectively operable closure to open or close the flow passage in order to control a flow of fluid through the valve. The sealing integrity of high pressure valves must withstand not only high operating fluid pressures, which could be 5,000 pounds per square inch and higher, but also must do so while controlling the flow of corrosive and/or abrasive fluids that are notorious for eroding the valve internal components in the oil and gas industry. While 5,000 psi is listed herein, it should be understood that valves of this type are often subjected to working pressures of 10,000 psi, 15,000 psi, or more. The 5,000 psi number should only be considered a “floor”, below which conditions would not be considered “high pressure” in the hydraulic fracturing and oil and gas industries.

Illustrative embodiments herein are directed to a plug valve although the contemplated embodiments are not so limited. In a plug valve the flow passage typically includes a valve body in fluid communication with two or more openings, typically an inlet opening and an outlet opening, forming a flow passage through the valve body. A valve plug and insert segments, one type of a valve closure that is described herein, are disposed in a valve body bore between the inlet and outlet openings where sealing occurs between the plug, the insert, and the bore.

The valve plug defines a through-opening and is selectively rotatable to an open position where the through-opening is aligned with the flow passage to permit a flow of fluid through the valve (from the inlet to the outlet), or to a closed position where the through-opening is misaligned with the flow passage to prevent the flow of fluid through the valve. Fluid travelling through the valve is often a fracturing fluid or “frac” fluid. Such fluid is water-based, but includes additives that assist in the fracturing of a downhole formation. These additives may include acids, such as hydrochloric acid. They may also include corrosion or scale inhibitors. Finally, frac fluid often includes suspended “proppants”—often sand or silica—which is used to “prop” open fissures in downhole formations. Such proppants enable additives to reach deeper into formations in oil and gas operations.

Operating a valve at high pressure conditions with acidic fluid containing abrasive proppant material can cause erosion of the location where the seal in the insert contacts the bore, often resulting in leakage in a week. Repairing the valve body, such as by a weld build-up and machining operation, is a cumbersome and disruptive repair in the oilfield.

For this reason, it is advantageous to transfer the wear from the valve body to smaller, replaceable parts like the aforementioned inserts. By transferring the seating location of the seal from the insert to the valve body, the wear associated with the seal is moved from the valve body to the seal. While challenges exist in forming such a seal groove, the following description is of one such seal groove formed in a valve body to improve the hierarchy of wear in a valve body.

### SUMMARY

The present invention is directed to a valve comprising a valve body, at least two elongate inserts and a rotatable plug. The valve body has a valve chamber formed therein. The valve chamber also has a pair of opposed ports formed therein, each port communicating with a fluid conduit. The inserts cooperate to form a cage positioned within the valve chamber. Each insert has a convex surface that is interrupted by a fluid conduit that extends through the cage. The convex surface is bounded by edges formed at or near the longitudinal extremities of the insert. The rotatable plug is penetrated by a fluid conduit and positioned within the cage. A recess is disposed within the valve body about each of the opposed ports.

### BRIEF DESCRIPTION OF THE DRAWINGS

FIG. 1 is a sectional side view of a plug valve with a groove formed in its body around an inlet and outlet.

FIG. 2 is a top left perspective view of the plug valve with the interior of the plug valve bore in view.

FIG. 3 is a sectional side view of the plug valve with the plug closed.

FIG. 4 is a bottom perspective view of inserts for use with the plug valve.

FIG. 5 is a bottom view of the inserts of FIG. 4.

FIG. 6 is a partially sectional perspective view of the plug valve with the inserts shown unsectioned within the bore.

FIG. 7 is an exploded view of the plug valve.

FIG. 8 is a sectional side view of an alternative plug valve.

FIG. 9 is a top right perspective of a valve body for use with flanges to form the plug valve of FIG. 8.

FIG. 10 is a flange for use with the plug valve of FIG. 8 having a groove formed about its through-opening.

FIG. 11 is a flange for use with the plug valve of FIG. 8.

### DETAILED DESCRIPTION

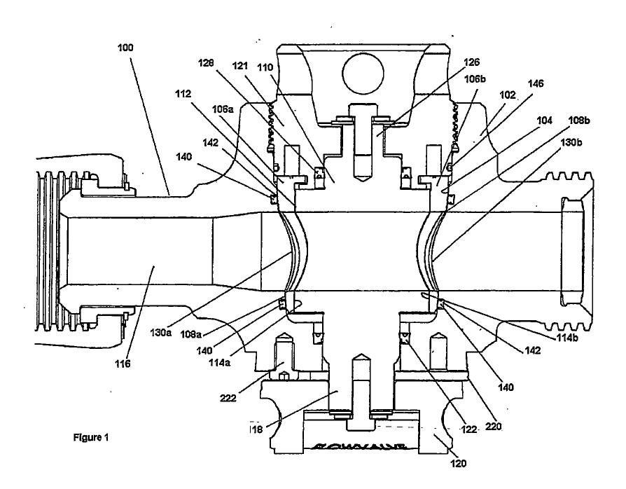

FIGS. 1-3 depict plug valve 100. The plug valve 100 has a forged valve body 102 forming an enlarged internal chamber, or internal bore 104. As shown, the internal bore 104 is complementary to a tapered cylinder, or conical frustum. However, a cylinder without a taper or one with flat rectangular ends may be utilized for the internal bore. The valve body 102 is a single-piece construction, which will influence the difficulty of machining a groove in the chamber 104.

Inserts 106a, 106b in these illustrative embodiments are segments of an open hollow cone. Although two inserts 106a, 106b are depicted, the contemplated embodiments are not so limited because alternatively there can be more than two. In embodiments with more than two inserts 106a-b, there may be inserts without flow passages. The inserts with flow passages through them may be identically shaped and sized. As shown, each insert 106a, 106b has an outer conical surface 108a, 108b forming a matching taper to engage against the bore 104 in a close mating relationship. Each insert 106a-b is formed from a body having an inner surface and a spaced outer surface. The outer surface should have a shape complementary to that of the valve chamber. Preferably, the inner surface is concave, and the outer surface is convex.

A plug 110 has an outer diameter surface 112 sized to fill the space between the inserts 106a-b, mating with an inner diameter surface 114a, 114b of the respective inserts 106. As shown the plug 110 is partially cylindrical, and at least a portion of its outer surface is congruent with a portion of the curved side of a cylinder. The plug 110 has a journal 118 that is rotatable by a handle 120. A packing 122 seals against the journal 118 to contain the pressurized fluid inside the valve 100 while permitting an external force to rotate the journal 118 and, in turn, the plug 110. Alternatively the journal 118 can be rotated by a powered actuator. The plug no also has a second journal 126 that rotates within the body 102 and is sealed by packing 128.

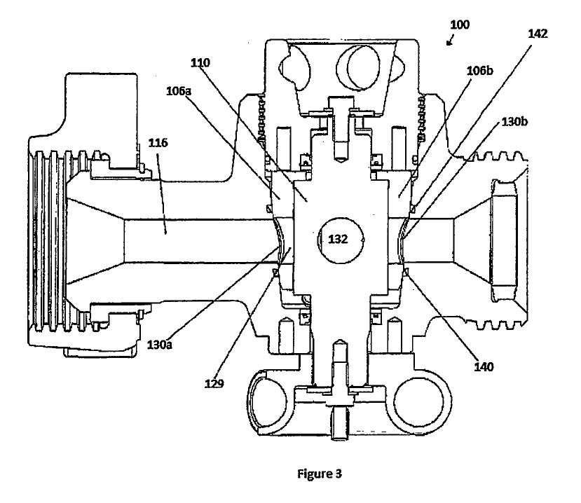

Inserts 106a-b cooperate with and surround the plug 110. There may be two inserts 106a-b, as shown, or more inserts, where only two of the inserts 106a-b form a flow opening 129 (FIG. 3) extending therethrough. The flow opening 129 interconnects the inner and outer surfaces of the inserts 106a-b. As shown, no groove or seal is formed on or in the insert 106a-b surrounding the flow opening 129. The inserts 106a-b provide an internal metal-metal seal with the rotatable plug no while seating against the internal bore 104. Thus, the inserts 106a-b may have an inner surface having a center of curvature coincident with the axis of rotation of the plug 110. Additionally, each insert 106a-b may have a center of curvature that it does not fully enclose.

The inserts 106a-b and rotatable plug 110 may be made from a durable metallic material. This may be the same or a different alloy than used in the valve body 102. Inserts 106a-b and the plug no being smaller and more simply formed than the valve body 102, are easier to treat. Inserts 106a-b and plug no can therefore be heat treated, treated with chemicals, or made with wear-resistant alloys in order to improve the life of the valve 100.

To enclose the plug no and support the journal 126, a retaining nut 121 may be threaded to the valve body 102. The retaining nut 121 seals to the valve body bore 104 by seal 146. The seal 146 may be situated in a groove formed either within the retaining nut 121 or in the valve body 102. Although a radial seal is depicted, in alternative embodiments an axial seal or a crush seal and the like can be used instead of or in addition to the radial seal 146.

The body 102 also defines a fluid flow path 116 intersecting the bore 104. The fluid flow path 116 has a longitudinal axis normal to the rotational axis of the plug is element and the axis of symmetry (if any) of the valve chamber 104. Each insert 106a-b may form an insert flow opening 129, and the inserts 106a-b are mounted in the valve 100 so that the insert openings 129 are aligned with the fluid flow path 116 and openings 130a-b formed in the valve body 102. The openings 130a-b may be an inlet or an outlet depending on the direction of fluid flow through the valve 100. The plug no forms a through-opening 132 permitting a user to selectively align the opening 132 with the openings 129 and 130a-b. FIG. 1 depicts the open position of the valve 100, where the plug 110 is rotated so that the through-opening 132 is aligned with the fluid flow path 116.

While the bore 104 and inserts 106a-b shown are a tapered cylinder (or, in other words, a conical frustum), the bore may instead be a right cylinder. Additionally, the inserts 106a-b may have a flat external surface to conform to a bore with a rectangular or square cross-sectional shape.

The body 102 is preferably formed of a high-strength metal material, such as steel. Forged steel provides the durability and strength necessary to operate in high-pressure conditions over 5000 psi. The plug valve 100 may be rated to as much as 10,000 psi, 15,000 psi, or more.

The openings 130a-b are each surrounded by a seal 140 seated in a groove 142. The groove is formed in the bore 104 of the valve body 102 at a uniform distance from the closest point on the boundary of its associated opening 130a-b. In this configuration, the seal 140 seats on three sides against the groove 142 and on a fourth side against a surface of the corresponding insert 106a-b. Wear due to interaction between the seal 140 and the surfaces it contacts is primarily on the insert 106a-b, rather than on the valve body 102. Previous designs, such as that found in U.S. Pat. No. 2,813,695 issued to Stogner, placed a seal in the insert, and caused the wear to be most prevalent on the valve body.

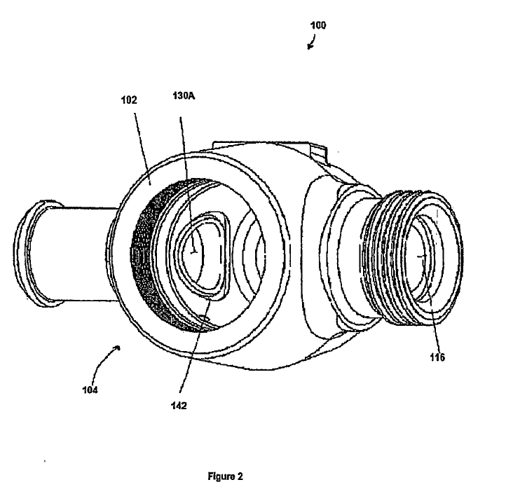

With reference now to FIG. 2, the valve 100 is shown with retaining nut 121 removed, such that the bore 104 of the valve body 102 is shown. The groove 142 is disposed about the first opening 130a without a seal 140 (FIG. 1) seated within. The opening 130a is defined by the intersection of the fluid flow path 116 and the bore 104. As shown, the fluid flow path 116 is cylindrical, and the bore 104 is a conical frustum. The opening 130a is formed at the three-dimensional intersection of these two shapes.

Likewise, the groove 142 is formed on the internal surface of the bore 104. The groove 142 is formed in the valve body 102 at a uniform distance from the closest point on the boundary of its associated opening 130a-b. As shown, the groove 142 is shaped as a circle projected onto the inner surface of a conical frustum. The cross-section of the groove 142 is substantially rectangular, with a bottom surface of the groove being parallel to the internally-disposed surface of the bore 104. The sides of the groove 142 are perpendicular thereto. Alternatively, the sides of the groove 142 may be parallel to the fluid flow path 116. The groove 142 may have a uniform depth.

Positioned in this way, the seal 140 (FIG. 1) is evenly distributed about the opening 130a (and opening 130b, not shown in FIG. 2). The seal 140 may be manufactured to fit in the groove 142 or may be a circular seal that is stretched to fit into the groove 142.

Machining such a non-Euclidean groove 142 on the surface of a unitary valve body 102 requires precise and small tools, and is much more difficult than machining a similar shape on an insert 106a-b, as in prior art valves. However, any difficulty in machining is made up for in the transfer of the wear from the valve body 102 to a replaceable insert 106a-b.

Seals 140 are shaped differently than the inserts 106a-b. Seals 140 are generally elastomeric rings which may be seated in grooves such as groove 142. Inserts 106a-b, as described above, are metallic pieces which allow the plug to rotate within one or more of the inserts, while complementing the internal bore 104 of the valve body 102.

With reference now to FIG. 3, the valve 100 is shown with the plug 110 in a closed position. In the closed position, pressurized fluid within the fluid flow path 116 impacts against the closed plug 110, sealing the plug 110 in a metal-to-metal seal against the insert 106a. The insert 106a is sealed by seal 140 mounted in the groove 142 formed in the valve body bore 104 (FIG. 2). Thus, in the closed position the pressurized fluid is blocked from flowing through the valve 100. By rotating the plug no to the open position as in FIG. 1, its through-opening 132 comes into alignment with the openings 130a-bin the inserts 106a-b, permitting the pressurized fluid to flow through the valve 100 via the fluid flow passage 116.

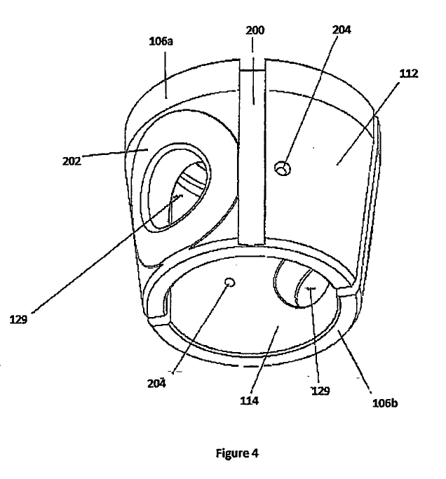

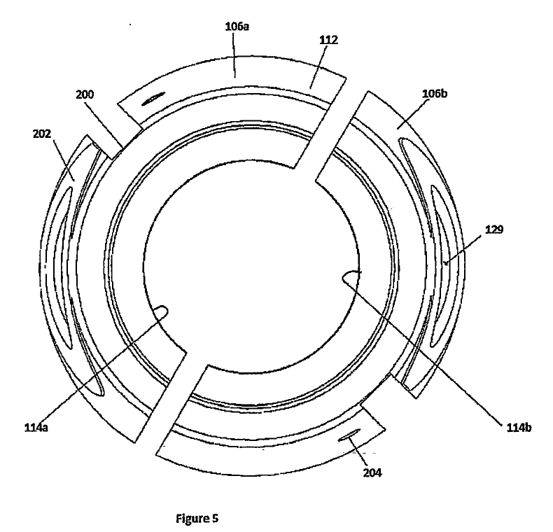

With reference to FIGS. 4-5, the inserts 106a-bare shown therein. The inserts 106a-b comprise an external key groove 200 and a raised sealing surface 202. The raised sealing surface 202 provides an interface for the seals 140 (FIG. 1). While a raised surface 202 may be advantageous to proper sealing, it is not strictly necessary. As shown, the sealing surface 202 surrounds each insert opening 129 formed in the inserts. As best shown in FIG. 5, the external surface 112 of the insert 106a-b is a conical frustum, while the interior surfaces 114a-b are complementary to a cylinder.

A small pressure-relief port 204 allows high pressure fluid trapped within the through passage 132 of the plug 110 (FIG. 3) to release. Such release prevents damage to the valve 100 due to temperature and pressure changes within the closed plug 110.

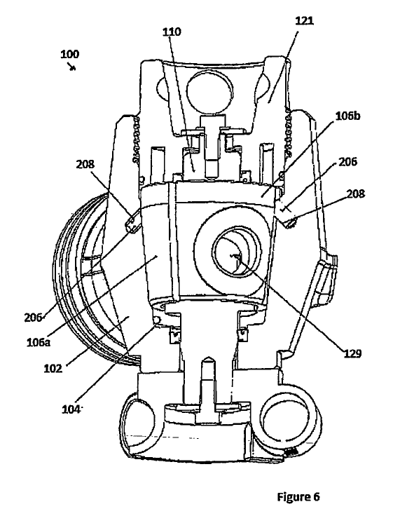

With reference to FIG. 6, the valve 100 is shown in cross-section with the insert 106a-b shown. A key 206 is formed in a key recess 208 in the valve. The key 206 interfaces with the key groove 200 formed in each insert 106a-b. The key prevents the insert 106a-b from rotating within the valve body 102. In FIG. 6, the key recess 208 is shown proximate the retaining nut 121, though the vertical position of the key recess 208 and key 206 is not limiting. As shown, the key 206 is a cylindrical dowel pin, though other constructions may be utilized to prevent rotation of the insert 106a-b.

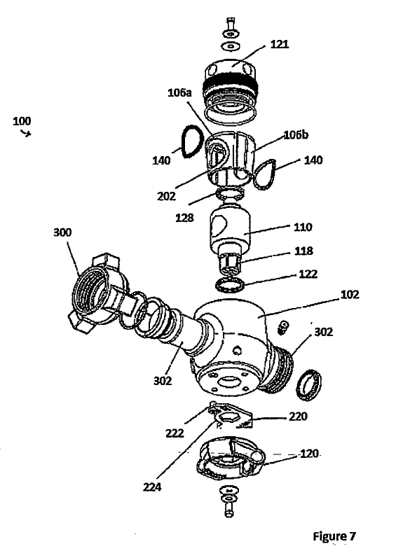

With reference now to FIG. 7, the valve 100 is shown in exploded view, in accordance with the previous description. The handle 120 interfaces with a travel limiter 220 and the journal 118 of the plug 110. The journal 118 is shown as a hexagonal prism to be disposed through an aperture in the valve body 102, limiter 220, and handle 120. The travel limiter 220 interfaces with a stop screw 222 attached to the valve body 102. Thus, the limitation on rotational travel of the plug 110 within the valve body 102 is given by a recessed portion 224 of the travel limiter 220. The limiter 220 and stop screw 222 are shown from the side in FIG. 1.

The inserts 106a-b are disposed about the plug 110. The seals 140 are shown opposite the sealing surface 202 as grooves 142 are not shown in FIG. 7. Packing seals 122 and 128 are shown.

The valve 100 comprises two ports 302. As shown, the ports 302 are integrally formed with the valve body 102. An adaptor 300 may be provided proximate the valve 100 for threaded attachment to pipes or other components.

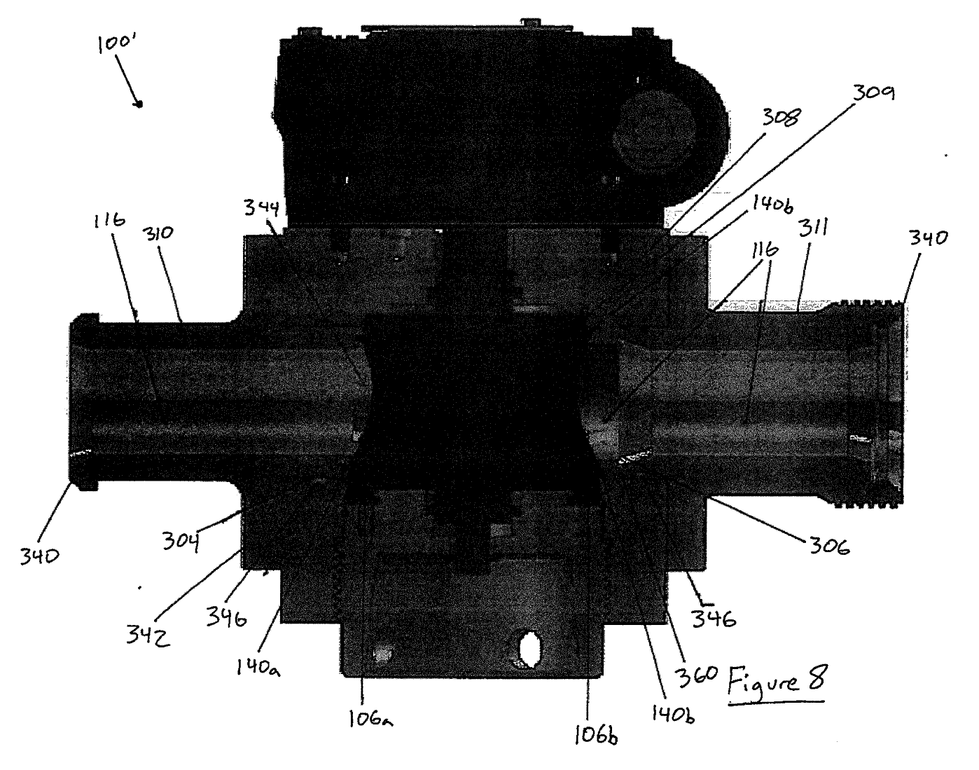

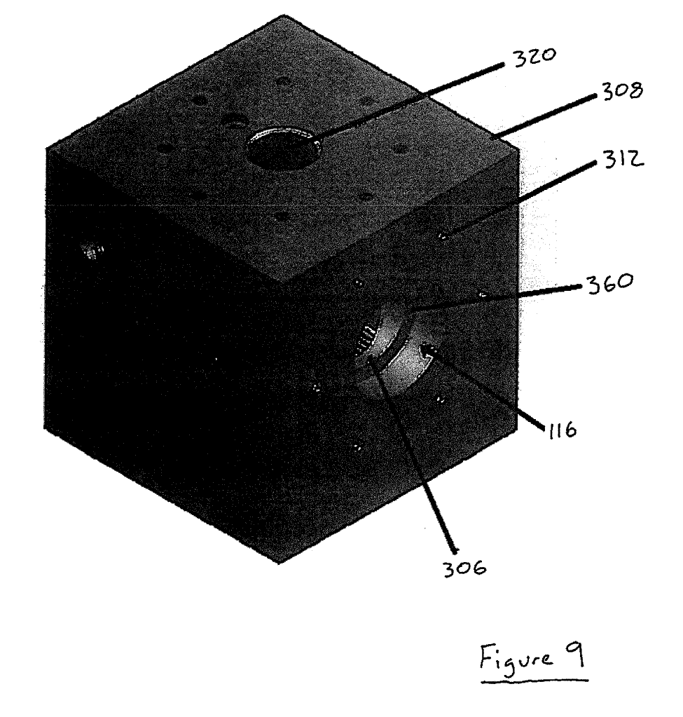

With reference to FIGS. 8-9, an alternate embodiment of the valve 100′ is shown. In this embodiment, ports 302 are replaced by bolt-on flanges 310, 311. In this embodiment, a modular valve body 308 comprises an inlet port 304 and an exit port 306, between which is the fluid flow path 116. As shown in FIG. 9, the modular valve body 308 defines a plurality of connection points 312 disposed about the exit port 306. A similar set of connection points 312 are disposed about the inlet port 304 (FIG. 8). The connection points 312 may be threaded or splined bolt holes.

The valve body 308 may have a top port 320 for connection to handles, journals, and other internal components of the valve 100′. As shown in FIG. 9, valve body 308 is roughly a cube, though other shapes may be utilized without departing from the spirit of the invention disclosed herein.

Referring again to FIG. 8, each flange 310, 311 comprises a protuberant port 340, a ring 342, and an insert tube 344. The port 340 is adapted for connection to an upstream or downstream connection, and may define threads, splines, or other connection means, depending upon the connection required.

Axial seals 346 are formed between the insert tubes 344 and the valve body 308 at the inlet port 304 and exit port 306. As shown, the seal 346 is seated in the valve body 308 at the inlet port 304. The seal 346 is seated in the insert tube 344 of the flange 311 at the exit port 306. This arrangement is shown for illustrative purposes only and is not limiting on the invention. Representative seals 346 may be o-rings.

Valve 100′ is similar to valve 100 (FIG. 1) in that seal 140 is disposed in a groove 142 disposed such that inserts 106a-b receive wear, rather than the valve body 308. Groove 142 for seating the seal 140 may be disposed in the valve body 308 or the flange 310, 311. As shown, seal 140a is seated in the flange 310, while seal mob is seated in the valve body 308.

In the arrangement of FIG. 8, the insert tube 344 of flange 311 terminates at a shoulder 360 formed between the flange 311 and the valve body 308. The insert tube 344 of flange 310 terminates to form a portion conforming to an internal bore 309 of the valve body 308.

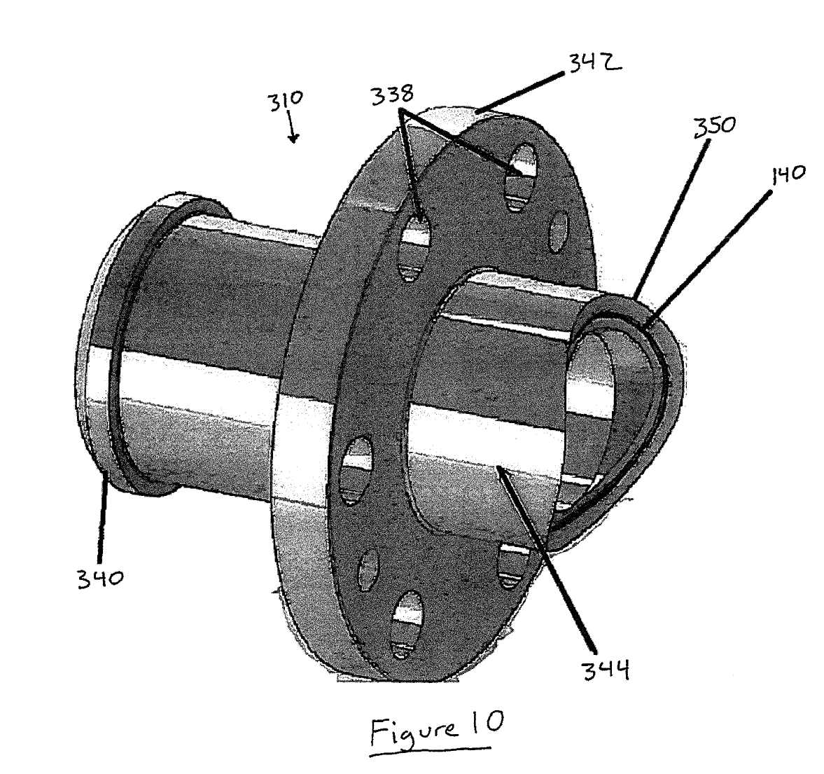

With reference to FIG. 10, the flange 310 is shown. The flange 310 defines holes 338 that conform to holes 312 formed in the outer surface of the valve body 308 (FIGS. 8-9). Bolts (not shown) or other connectors are used to affix the flange 310 to the valve body 308. As shown, the insert tube 344 terminates in a surface 350 conforming to the internal bore 309 of the valve body 308 (FIG. 8). Seal 140 is seated in the surface 350.

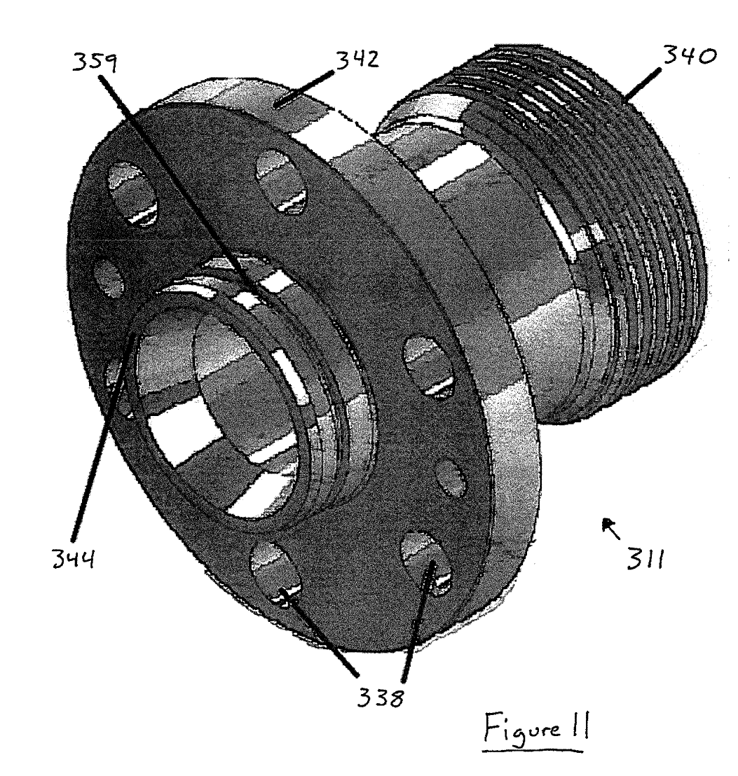

With reference to FIG. 11, second flange 311 is shown. The second flange 311 comprises an insert tube 344 having a seal groove 359 formed therein. Seal 346 may be placed in the groove 359 to seal the insert tube 344 to the valve body 308, as depicted in FIG. 8. Holes 338 are defined in the ring 342 for connection to the holes 312 proximate exit port 306 (FIG. 9). Connection between holes 338 and holes 312 may be made by bolts or other connectors.

Flanges 310, 311 are examples, and other embodiments are contemplated. For example, the surface 350 of flange 310 may be made larger such that it comprises a larger portion of the internal bore 309 wall in valve body 308. The internal bore 309 may be complementary to a rectangular prism such that square inserts are disposed between the plug and a flange having a flat surface 350.

In either the embodiment of FIG. 1 or FIG. 8, the plug valve 100, 100′ transfers the erosion wear from the bore of the body 102, 308 to the outer conical surface of the insert 106a-b. Failure of the valve due to leakage can occur because the free end of the seal 140 abrades away the outer conical surface of the insert 106a-b. Repair procedure may include resurfacing the insert 106a-b to provide a new sealing surface 202 for the seal 140 mounted in the body 102, 308. Alternatively, the insert 106a-b can simply be replaced with a new one. Redundant seals (not shown) disposed about seal 140 may be utilized to increase the sealing life of the insert.

1. A valve, comprising:
a body, comprising:
a flow passage including an inlet passage and an outlet passage; and
an enlarged internal chamber intersecting the flow passage and having a closed first groove formed in its surface, the first groove surrounding the flow passage at a first site joining the chamber;
a rotatable plug element positioned within the chamber, having a fluid passage extending therethrough, and having a portion of its external surface that is both alignable with the flow passage and congruent with a portion of the curved side of a cylinder; and
first and second insert elements positioned within the chamber and cooperating to at least partially surround the plug element, each insert element having a fluid opening extending therethrough and neither insert element positioned within the first groove.

2. The valve of claim 1 wherein the first groove has parallel side walls joined by a base.

3. The valve of claim 1 wherein the path followed by the first groove is non-planar.

4. The valve of claim 1 in which each insert element has an inner surface having a center of curvature coincident with the axis of rotation of the plug element.

5. A valve comprising:
a valve body having a valve chamber formed therein, the valve chamber having a pair of opposed ports formed therein, each port communicating with a fluid conduit;
at least two solid elongate inserts that cooperate to form a cage positioned within the valve chamber, each insert having a convex surface that is interrupted by a fluid conduit that extends through the cage, the convex surface bounded by edges formed at or near the longitudinal extremities of the insert; and
a rotatable plug penetrated by a fluid conduit and positioned within the cage;
wherein a recess is disposed within the valve body about each of the opposed ports.

6. The valve of claim 5 wherein the valve chamber is a shape complementary to a right conical frustum.

7. The valve of claim 6 wherein the recess is a uniform depth.

8. The valve of claim 6 wherein the recess connects points of equal distance from a single point on an axis extending through one of the pair of opposed ports.

9. The valve of claim 5 wherein the valve chamber is a shape complementary to a cylinder.

10. The valve of claim 9 wherein the recess is a uniform depth and connects points of equal distance from a single point on an axis extending through one of the pair of opposed ports.

11. The valve of claim 5 in which each insert is characterized as having a smooth concave surface that extends in opposed relationship to the convex surface and is interrupted, if at all, only by a fluid conduit that extends through the cage, the concave surface bounded by edges formed at or near the longitudinal extremities of the insert.

12. The valve of claim 11 in which the concave surface of the insert and an external surface of the plug are substantially complementary.

13. The valve of claim 12 wherein no seal is disposed between the external surface of the plug and the concave surface of the insert.

14. The valve of claim 5 wherein a seal is disposed within the recess.

15. The valve of claim 5 wherein the seal directly contacts one of the at least two elongate solid inserts.

16. A valve comprising:
a valve body having a valve chamber formed therein, the valve chamber having:
a surface defining a shape complementary to the lateral surface of a right conical frustum;
a pair of opposed fluid ports formed in the surface; and
a groove formed in the surface and surrounding each port.

17. The valve of claim 16 wherein each groove connects points of equal distance from an axis extending through its associated port.

18. The valve of claim 17 wherein the groove is of uniform depth relative to the surface.

19. The valve of claim 16 wherein a seal is disposed within the groove.

20. The valve of claim 19 further comprising a rotatable cylindrical plug defining a central passage that is in selective fluid communication with the pair of opposed fluid ports.

21. The valve of claim 20 further comprising at least one insert disposed between the cylindrical plug and the surface of the valve chamber.

22. The valve of claim 21 wherein a seal is disposed within the groove such that the seal directly abuts the insert.

23. The valve of claim 21 wherein the at least one insert has a concave surface complimentary to the cylindrical plug and an opposed convex surface substantially conforming to the surface of the valve chamber.

24. The valve of claim 21 wherein no seal is disposed between the at least one insert and the cylindrical plug.

25. The valve of claim 21 wherein the at least one insert is fixed in position relative to the valve body.
